(19) United States
(12) Patent Application Publication
(10) Pub. No.: US 2017/0206852 A1
(43) Pub. Date: Jul. 20, 2017

(54) DATA LINE DRIVING METHODS, DATA LINE DRIVING UNITS, SOURCE DRIVERS, PANEL DRIVING DEVICES AND DISPLAY DEVICES

(71) Applicants: BOE Technology Group Co., Ltd., Beijing (CN); Hefei BOE Optoelectronics Technology Co., Ltd, Anhui (CN)

(72) Inventors: Lingling Liu, Beijing (CN); Jian He, Beijing (CN); Jiacheng Huang, Beijing (CN)

(21) Appl. No.: 15/327,733

(22) PCT Filed: Jan. 22, 2016
(86) PCT No.: PCT/CN2016/071742

§ 371 Date: Jan. 20, 2017

(30) Foreign Application Priority Data
Jul. 6, 2015 (CN) 201510395777.7

(51) Int. Cl. G09G 3/36

(52) U.S. Cl. CPC G09G 3/3696; G09G 3/3677; G09G 3/3688; G09G 2310/08; G09G 2310/061; G09G 2310/0248

(57) ABSTRACT

The present disclosure discloses data line driving methods, data line driving units, source drivers, panel driving devices and display devices capable of reducing power consumption due to charge and discharge of the parasitic capacitance on the data line. The data line driving method comprises steps of: determining whether current time is within a blanking period of time between two frames; outputting a preset voltage signal to the data line on a condition that the current time is within the blanking period of time and outputting a gray-scale voltage signal to the data line on a condition that the current time is not within the blanking period of time.

### CROSS-REFERENCE TO RELATED APPLICATION(S)

This application claims the benefit of Chinese Patent Application No. 201510395777.7 filed on Jul. 6, 2015 and entitled “DATA LINE DRIVING METHODS, DATA LINE DRIVING UNITS, SOURCE DRIVERS, PANEL DRIVING DEVICES AND DISPLAY DEVICES”, which is incorporated herein by reference in entirety.

### FIELD OF INVENTION

The present disclosure relates to the field of display, and particular to data line driving methods, data line driving units, source drivers, panel driving devices and display devices.

### BACKGROUND

Liquid crystal displays (LCD) have various advantages, such as zero radiation, low power consumption, small heat radiation, small size, accurate image reproduction, sharp character display, etc., and currently have become the most popular display products.

A displaying process of LCD is shown as follows: the source driving integrated circuit (IC) supplies the data lines with a gray-scale voltage corresponding to luminance (i.e., GAMMA voltage), and then the scanning lines supply on-state voltage to turn on thin film transistor (TFT) switches. The voltage at the corresponding data line is loaded to pixel electrodes through the data line and the TFT switch to charge the liquid crystal capacitance Cps to form a gray-scale and thus to display images. At the same time, there are many parasitic capacitances on the whole data line, and an end electrode of each capacitance (such as Cx1, Cx2, Cd0, Cpd in FIG. 1) is connected to the data line. Therefore, when the data line charges and discharges the capacitance of liquid crystal Cps, it also charges and discharges these parasitic capacitances, resulting in unnecessary power consumption.

At present, dielectric anisotropy and optical anisotropy of the liquid crystal molecule are utilized to obtain different displaying gray scales. In order to prevent liquid crystal molecules from being solidified for being at a certain voltage for a long period of time, an AC driving mode is adopted to maintain characteristics of the liquid crystal molecules. However, the AC driving mode means that the data line voltage will change constantly, which will lead to continuous charging and discharging of the above-mentioned parasitic capacitances. This will generate leakage current on the data lines, increase load of the source-driven chip and cost more power consumption.

### SUMMARY OF THE INVENTION

The present disclosure provides data line driving methods, data line driving units, source drivers, panel driving devices and display devices capable of reducing power consumption due to charging and discharging of parasitic capacitances on a data line.

In order to at least solve the above technical problems, embodiments of the present disclosure utilize the following technical solutions.

The present disclosure provides a data line driving method comprising steps of: determining whether current time is within a blanking period of time between two frames; outputting a preset voltage signal to the data line on a condition that the current time is within the blanking period of time and outputting a gray-scale voltage signal to the data line on a condition that the current time is not within the blanking period of time.

Alternatively, the preset voltage signal is a common voltage signal.

Alternatively, the determining step comprises determining, by a data enabling signal, whether the current time is within the blanking period of time between two frames.

Alternatively, the outputting step comprises: generating a control signal for connecting an input terminal of the data line to the common voltage circuit on a condition that the current time is within the blanking period of time and generating a control signal for connecting the input terminal of the data line to a source driving circuit on a condition that the current time is not within the blanking period of time; and connecting the input terminal of the data line to the common voltage circuit or the source driving circuit according to the control signal.

The present disclosure provides a data line driving unit comprising: a determining unit configured for determining whether current time is within a blanking period of time between two frames; a switching unit configured for connecting an input terminal of the data line to a preset voltage signal generating circuit on a condition that the determining unit determines that the current time is within the blanking period of time, and connecting the input terminal of the data line to a source driving circuit on a condition that the determining unit determines that the current time is not within the blanking period of time.

Alternatively, the determining unit is further configured for generating a control signal for connecting the input terminal of the data line to the preset voltage signal generating circuit on a condition that it is determined that the current time is within the blanking period of time, and generating a control signal for connecting the input terminal of the data line to the source driving circuit on a condition that the current time is not within the blanking period of time.

Alternatively, the preset voltage signal generating circuit is a common voltage circuit.

Alternatively, a control terminal of the switching unit is connected to the determining unit, a first input terminal of the switching unit is connected to the source driving circuit, a second input terminal of the switching unit is connected to the common voltage circuit, and an output terminal of the switching unit is connected to the input terminal of the data line; and the switching unit receives the control signal from the determining unit and connects the input terminal of the data line to the source driving circuit or the common voltage circuit according to the control signal.

Alternatively, the determining unit determines, by a data enabling signal, whether the current time is within the blanking period of time between the two frames.

The present disclosure provides a source driver comprising a source driving circuit and a preset voltage signal generating circuit and further comprising: a determining unit configured for determining whether current time is within a blanking period of time between two frames; and a switching unit configured for connecting an input terminal of the data line to the preset voltage signal generating circuit on a condition that the determining unit determines that the current time is within the blanking period of time, and connecting the input terminal of the data line to the source driving circuit on a condition that the determining unit determines that the current time is not within the blanking period of time.

Alternatively, the determination unit is a timing controller.

Alternatively, the determining unit determines, by a data enabling signal, whether the current time is within a blanking period of time between two frames.

Alternatively, the preset voltage signal generating circuit is a common voltage circuit.

The present disclosure further provides a panel driving device comprising a data line driving unit according to any one of the above mentioned embodiments or a source driver according to any one of the above mentioned embodiments.

The present disclosure further provides another panel driving device including a timing controller and a source driver, wherein the source driver includes a source driving circuit and a preset voltage signal generating circuit; the timing controller is configured for determining whether current time is within a blanking period of time between two frames, generating a control signal for connecting an input terminal of the data line to the preset voltage signal generating circuit on a condition that the current time is within the blanking period of time, and generating a control signal for connecting the input terminal of the data line to the source driving circuit on a condition that the current time is not within the blanking period of time; the source driver further comprises a switching unit configured for receiving the control signal outputted by the timing controller and selecting to connect the input terminal of the dada line to the preset voltage signal generating circuit or the source driving circuit according to the control signal.

The present disclosure also provides a display device comprising a panel driving device according to any one of the above mentioned embodiments.

The present disclosure provides data line driving methods, data line driving units, source drivers, panel driving devices and display devices. By only outputting a gray scale voltage signal to data lines during an active time interval for loading display data to display regions and outputting a preset voltage signal such as a common voltage signal to the data lines during the remaining blanking period of time (i.e. the blank time regions), the data line is maintained at a fixed voltage level during the whole blanking period of time so as to avoid charging and discharging of the parasitical capacitances. Thus, the leakage current on the data lines is almost zero so as to decrease power consumption of the panel. Since the output preset voltage signal on the data line is not actually applied to the capacitances of the liquid crystal during the blanking period of time between two frames, it will not affect the characteristic of the liquid crystal and can't bring any disadvantageous influence on display effect.

### DESCRIPTION OF THE DRAWINGS

In order to more clearly illustrate the technical solutions of the embodiments of the present disclosure, the drawings which are required to be used in the embodiments will be briefly described hereinafter. It will be apparent that the drawings described below are only some embodiments of the present disclosure, It will be apparent to those skilled in the art that other drawings may be acquired from of the accompanying drawings without departing from the inventive labors.

FIG. 1 is a schematic view of an equivalent circuit for pixel parasitic capacitances of a LCD provided by prior art;

FIG. 2 is a schematic view of a blanking period of time and an active time interval output by the source driver in an embodiment of the present disclosure;

FIG. 3 is a schematic view of a 1 Hz resting driving in the IGZO TFT according to an embodiment of the present disclosure;

FIG. 4 is a flowchart of a data line driving method according to an embodiment of the present disclosure;

FIG. 5 is a flowchart of a data line driving method according to an embodiment of the present disclosure;

FIG. 6 is a schematic view of generating a control signal according to an embodiment of the present disclosure;

FIG. 7 is a block diagram of a data line driving unit according to an embodiment of the present disclosure;

FIG. 8 is a schematic view of principle of the data line driving unit according to an embodiment of the present disclosure;

FIG. 9 is a schematic view of principle of the source driver according to an embodiment of the present disclosure;

FIG. 10 is a schematic view of another source driver according to an embodiment of the present disclosure.

### REFERENCE NUMERALS

10—display screen, 11—display area, 12 non-display area, 21—processor, 22—timing controller, 23—source driver, 24—source driving circuit, 25—common voltage circuit, 26—controllable switch, 27—data line input terminal, 100—determining unit, 200—switching unit.

### DETAILED DESCRIPTION OF PREFERRED EMBODIMENTS

In order to facilitate understanding of concepts of the blanking period of time and so on related to the technical solution of the present disclosure, the present embodiment briefly describes the related contents.

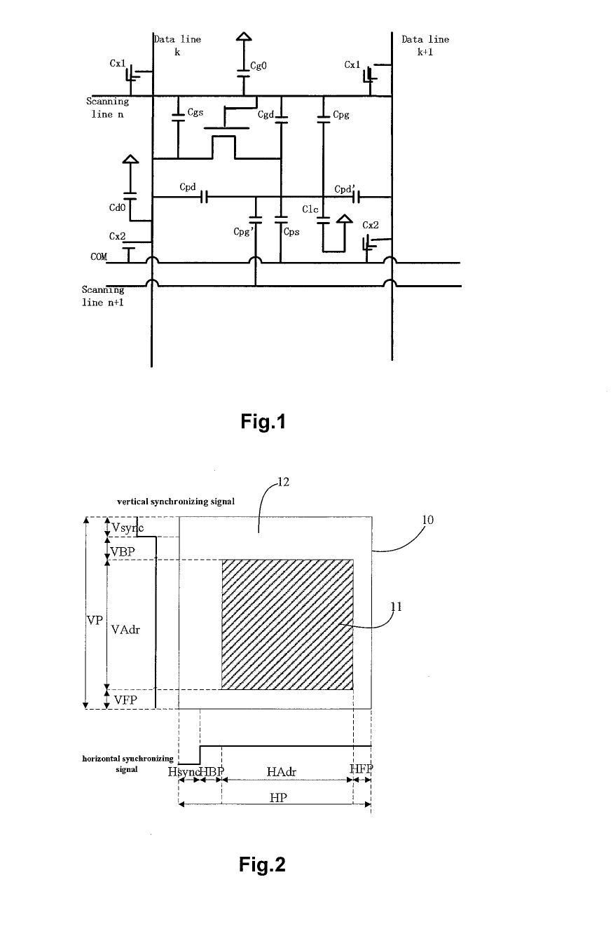

In the LCD technology, a source driving circuit directly outputs data to data lines, and the data outputted on each data line includes valid data (Vadr) and blanking data, which are distinguished according to numbers of clock pulses. As particularly shown in FIG. 2, a reference sign of 10 represents a LCD screen, a reference sign of 11 represents a display area at center of the display screen, and a reference sign of 12 represents a non-display area at periphery of the display screen. A vertical synchronizing signal and a horizontal synchronizing signal are regularly used signals in the display field, wherein the vertical synchronizing signal is used to control a length of one frame of picture and a length of its active time interval corresponds to the data length of one frame of picture. When the signal is loaded, the active time interval corresponds to display area at center of the display screen 10, i.e. valid data in the data line signals are loaded in the display area 11. A blanking period of time (also known as invalid time interval) of the vertical synchronizing signal corresponds to a length of time between two frames. When the signal is loaded, the blanking period of time is corresponding to the non-display area 12 of the display panel 10, i.e., blanking data is loaded in the non-display area 12. The blanking period of time in the present embodiment corresponds to a vertical front porch (VFP) or a vertical back porch (VBP) in the vertical synchronizing signal.

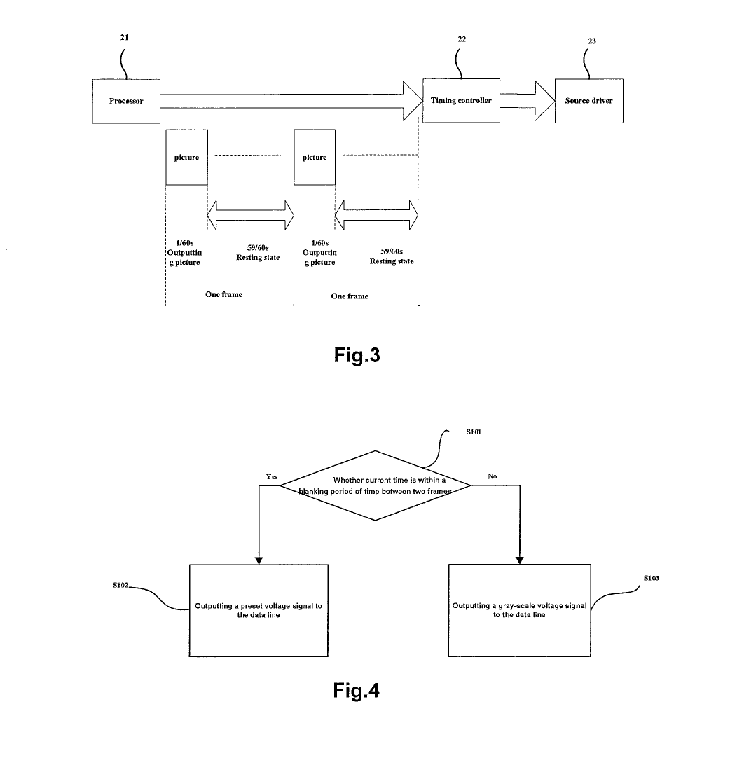

As shown in FIG. 3, when an Indium Gallium Zinc oxide (IGZO) TFT is used for resting driving of 1 Hz (or other low frequency driving), if a still picture is displayed, the frame is updated only during the first 1/60 second, and the screen is displayed in a resting state for the remaining 59/60 seconds. In the resting state, neither the processor 21 updates frame data to a timing controller (Tcon, also known as a timer control register) 22, nor could the timing controller 22 updates frame data to the source driver 23. That is to say, during this period of 59/60 seconds, the output of the source driver 23 is within the Blanking period of time.

In the above design, the source driver 23 outputs a pixel gray-scale voltage signal regardless of being in the frame updating state or the resting state. When the output is within a blanking period of time between the two frames, despite the data lines providing a gray-scale voltage signal, it is not displayed on the panel (corresponding to the non-display area 12 at this time), i.e. the liquid crystal capacitances are not charged or discharged. At this time, the voltage level of the entire data line keeps changing, resulting in that the parasitic capacitances on the entire data line is in a state of being continuously charge and discharged. Therefore, a certain amount of leakage current is generated in the data line and unnecessary power consumption is introduced.

With respect to the above problems, the present disclosure adjusts the voltage signal on the data line to be a preset voltage signal such as a common voltage signal during the blanking period of time between two frames until a valid data is output. The data line is maintained at a fixed voltage level during the whole blanking period of time so as to avoid charging and discharging of the parasitical capacitances. Thus, the leakage current on the data line is zero. Meanwhile, since such a driving during the blanking period of time is not actually applied to the capacitances of the liquid crystal during the blanking period of time, it will not affect the characteristic of the liquid crystal and can't bring any disadvantageous influence on display effect.

The technical solution of embodiments of the present disclosure would be clearly and completely illustrated in conjunction with accompany drawings of the embodiments of the present disclosure. It is obvious that the illustrated embodiments are only a part of the present disclosure and are not all of the embodiments.

An embodiment of the present disclosure provides a data line driving method comprising steps of: determining whether current time is within a blanking period of time between two frames; outputting a preset voltage signal to the data line if the current time is within the blanking period of time; and outputting a gray-scale voltage signal to the data line if the current time is not within the blanking period of time.

In the present embodiment, the blanking period of time is defined as a time interval between two frames, i.e. a time period from an end of loading a frame to a start of loading next frame. Alternatively, the present embodiment can determine, by a data enabling signal, whether the current time is within the blanking period of time between two frames, as will be described in detail in the following description. The preset voltage signal in the present embodiment is a voltage signal with a constant voltage level, which may be a common voltage signal or other constant voltage signal.

The present embodiment outputs a preset voltage signal to the data lines during the whole blanking period of time between two frames, so that the data line is maintained at a fixed voltage level so as to avoid charging and discharging of the parasitical capacitances. Thus, the leakage current on the data line is zero. Meanwhile, since such a preset voltage signal during the blanking period of time is not actually applied to the capacitances of the liquid crystal, it will not affect the characteristic of the liquid crystal and the display effect.

The data line driving method according to the present embodiment will be described in detail with reference to the accompanying drawings in which the preset voltage signal is taken as an example of the common voltage signal. As shown in FIG. 4, the present embodiment employs a data line driving method including the following steps:

Step S101, determining whether the current time is within a blanking period of time. If the current time is within the blanking period of time, the step S102 is executed. If the current time is not within the blanking period of time, the step S103 is executed.

Step S102, outputting a common voltage signal to the data line.

Step S103, outputting a gray-scale voltage signal to the data line.

Since the time period between the end of a frame and the start of next frame is the blanking period of time and there is a vertical synchronizing signal at the start of each frame, step S101 can determine whether the current time is within the blanking period of time between the two frames by the vertical synchronizing signal. In addition, the present embodiment does not exclude use of other signals and other methods to determine the blanking period of time. The result of the determination in the step S101 may directly function as a trigger signal for selecting to execute the step S102 or the step S103 at the next step. In addition, the trigger signal may be generated based on the determination result of the step S101 to control the next step of selecting whether to execute the step S102 or the step S103. The step S102 outputs the common voltage signal to the data line by connecting the input terminal of the data line to the common voltage circuit. The step of S103 outputs the gray-scale voltage signal to the data line by connecting the input terminal of the data line to the source drive circuit.

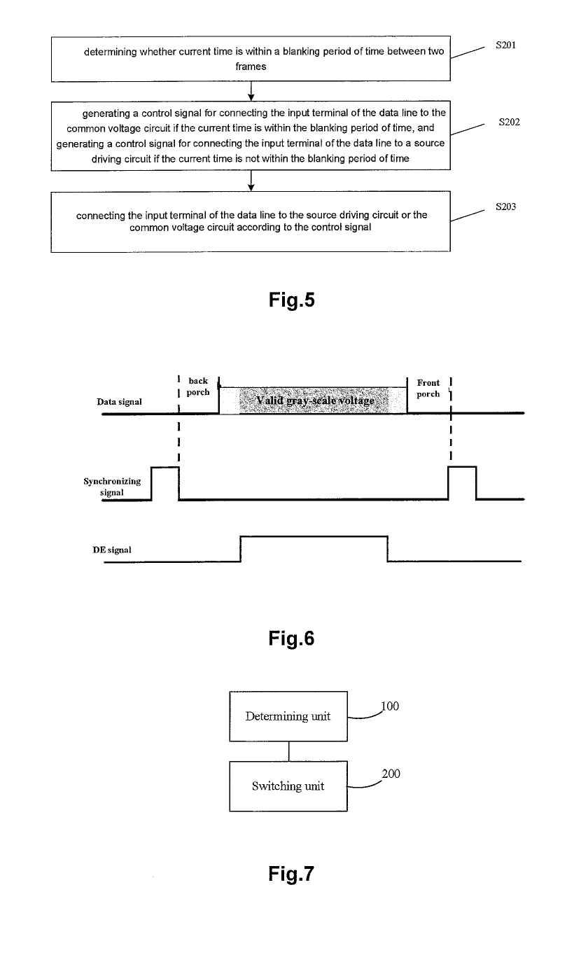

The data line driving method provided by the present embodiment is particularly shown in FIG. 5. As shown in FIG. 5, the data line driving method comprises the following steps: S201, determining whether the current time is within the blanking period of time between two frames; S202, generating a control signal for connecting the input terminal of the data line to the common voltage circuit if the current time is within the blanking period of time, and generating a control signal for connecting the input terminal of the data line to a source driving circuit if the current time is not within the blanking period of time; and S203, connecting the input terminal of the data line to the source driving circuit or the common voltage circuit according to the control signal.

Specifically, a video card is responsible for processing image material (data) sent from CPU into a form recognizable by the display and then sending to the display screen. In order for the data in the video card to be displayed correctly, it is needed to generate in a timing controller 22 a display data signal and a control signal for the driver through conversion. Since the output signal of the timing controller 22 is mainly generated by a counter, its timing depends on two factors, namely, the data structure and the display mode of the image signal. As shown in FIG. 6, the timing controller 22 may determine the set VBP/VFP/valid data to identify size and position of the valid pixel area, thereby to generate a data enabling signal (DE signal) for controlling a timing of the data output by the data line. Therefore, as long as a determining instruction is added to the timing controller 22, it is possible to realize the function of the determining unit to determine whether the current time is within the blanking period of time. The specific determining process is shown as follows.

For example, the 1 Hz resting driving for IGZO TFT is taken as an example. When the frame needs to be refreshed, the timing controller 22 outputs a DE signal for controlling the data line to output a data signal voltage (i.e., a gray-scale voltage signal). Each line will output a data enabling signal with a high level. Thus, as long as it is monitored whether the data enabling signal DE is at high level during two consecutive clock cycles, it may be determined whether the current time is within the blanking period of time. If the data enabling signal is at high level during the two consecutive clock cycles, it may be determined that it needs to be switched to data signal; otherwise, the common voltage signal is output. Of course, a functional module may be directly designed to determine whether the current time is within the blanking period of time, so that the timing controller will not be needed.

The data line driving method provided by the present embodiment determines whether to output a common voltage signal or to output a pixel voltage to the data lines according to whether the current time is within the blanking period of time. If the current time is within the blanking period of time between two frames, the signal on the data lines are adjusted to be the common voltage signal VCOM; otherwise, the gray scale voltage signal is output. Thus, the data line is maintained at a fixed voltage level during the whole blanking period of time between two frames so as to avoid charging and discharging of the parasitical capacitances of the data lines and to decrease power consumption of the panel. Meanwhile, since the loading of the common voltage signal is not actually applied to the capacitance of the liquid crystal during the blanking period of time between two frames, it will not affect the characteristic of the liquid crystal and the display effect.

As shown in FIG. 7, the embodiment of the present disclosure also provides data line driving unit comprising: a determining unit 100 configured for determining whether current time is within a blanking period of time between two frames; a switching unit 200 configured for connecting an input terminal of the data line to a preset voltage signal generating circuit (e.g. a common voltage circuit) on a condition that the determining unit 100 determines that the current time is within the blanking period of time, and connecting the input terminal of the data line to a source driving circuit on a condition that the determining unit 100 determines that the current time is not within the blanking period of time. The data line driving unit may decrease power consumption of the panel; and meanwhile, it won't affect the characteristic of the liquid crystal and the display effect.

The determining unit 100 of the present embodiment is further configured for generating a control signal for connecting the input terminal of the data line to the preset voltage signal generating circuit if it is determined that the current time is within the blanking period of time, and generating a control signal for connecting the input terminal of the data line to the source driving circuit if the current time is not within the blanking period of time. Alternatively, the determining unit 100 determines, by the data enabling signal, whether the current time is within the blanking period of time between the two frames. In a particular implementation, the determining unit 100 may be comparator or other logic devices or a determining instruction may be directly added to the timing controller 22 to implement the function of the determining unit 100.

The preset voltage signal generating circuit is configured to generate a voltage signal with a constant voltage level. Preferably, the preset voltage signal generating circuit is a common voltage circuit or a common voltage generating circuit inside the source driver, or a common voltage circuit on the panel. The common voltage circuit is taken as an example to be illustrated in detail. In the present embodiment, a control terminal of the switching unit 200 is connected to the determining unit 100, a first input terminal of the switching unit 200 is connected to the source driving circuit, a second input terminal of the switching unit is connected to the common voltage circuit, and an output terminal of the switching unit is connected to the input terminal of the data line. The switching unit 200 receives the control signal of the determining unit and connects the input terminal of the data line to the source driving circuit or the common voltage circuit according to the control signal.

In the present embodiment, the data line driving unit adjusts the signal on the data line to be the common voltage signal VCOM during the blanking period of time between the two frames, and the phenomenon of charging and discharging of the parasitic capacitances on the data line can be neglected so as to decrease power consumption of the panel without affecting the display effect. The present disclosure put no limitation on how to determine whether the current time is within the blanking period of time between the two frames and how to output the VCOM voltage to the data line, which may be any one of the implementations known to those skilled in the art.

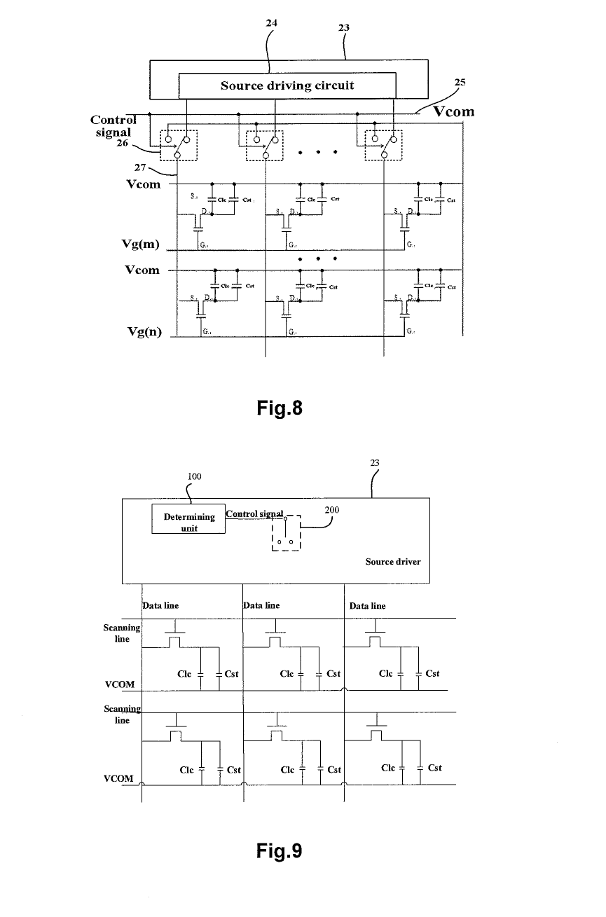

In one alternative implementation, the input terminal of the data line is provided with a switching unit such as a controllable switch, as particularly shown in FIG. 8. An input terminal 27 of each data line is connected to an output terminal of the controllable switch 26. The first input terminal of the controllable switch 26 is connected to a corresponding output terminal of the source driving circuit 24 and the second input terminal of the controllable switch 26 is connected to a common voltage circuit 25 (which may be a common voltage output terminal of the source driver 23 or a common electrode line). The control terminal of the controllable switch 26 receives control signals from the determining unit 100. The controllable switch 26 selects to connect the input terminal 27 of the data line to the source driving circuit 24 or the common voltage circuit 25 according to the control signal.

When it is determined that the current output of the source driver 23 is within the blanking period of time, the determining unit 100 supplies a trigger signal to trigger the controllable switch 26 to be switched, so that the data line is connected to the common voltage circuit 25 to obtain and output the common voltage VCOM to decrease power consumption. When it is determined that the current output of the source driver 23 in a valid data output stage (not within the blanking period of time), the trigger signal is again supplied to trigger the controllable switch 26 to switch to connect the data line to the source drive circuit 24. The data line receives and outputs the gray-scale voltage signal from the source driving circuit 24 to realize display.

An embodiment of the present disclosure further provides a source driver. As shown in FIG. 9, the source driver comprises a source driving circuit and a preset voltage signal generating circuit. The source driver further comprises: a determining unit 100 configured for determining whether current time is within a blanking period of time between two frames; and a switching unit 200 configured for connecting an input terminal of the data line to the preset voltage signal generating circuit when the determining unit determines that the current time is within the blanking period of time (the result of which is to output a preset voltage signal to the data line), and configured for connecting the input terminal of the data line to the source driving circuit when the determining unit 100 determines that the current time is not within the blanking period of time (the result of which is to output the gray scale voltage signal to the data line). Alternatively, the determining unit 100 determines, by the data enabling signal, whether the current time is within the blanking period of time between the two frames. The function of the determining unit 100 may be integrated into the timing controller internal to the source driver and the determining unit may be a separate functional module as shown in FIG. 9.

An embodiment of the present disclosure further provides a panel driving device comprising the data line driving unit according to any one of the above mentioned items or the source driver according to any one of the above mention items. The source driver provided by the embodiments of the present disclosure has lower power consumption without disadvantageously affecting the display effect.

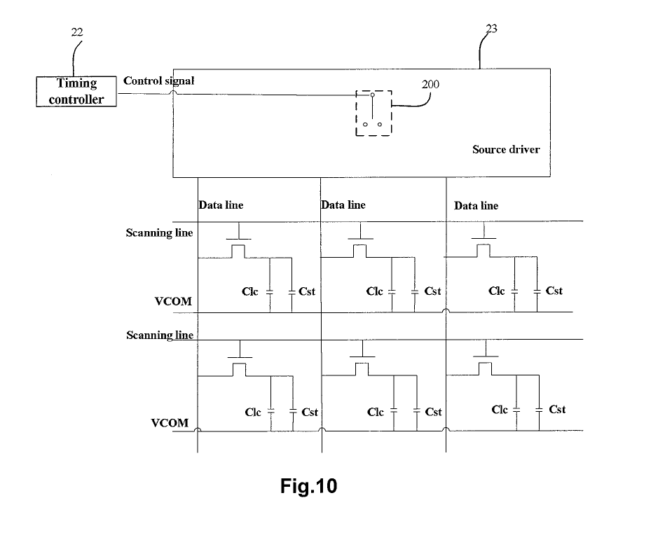

An embodiment of the present disclosure further provides another panel driving device. As shown in FIG. 10, the panel driving device comprises a timing controller 22 and a source driver 23, wherein the source driver 23 includes a source driving circuit and a preset voltage signal generating circuit. The timing controller is configured for determining whether current time is within a blanking period of time between two frames, generating a control signal for connecting the input terminal of the data line to the preset voltage signal generating circuit when the current time is within the blanking period of time, and generating a control signal for connecting the input terminal of the data line to the source driving circuit when the current time is not within the blanking period of time. The source driver 23 further comprises a switching unit 200 for receiving the control signal outputted by the timing controller 22 and selecting to connect the input terminal of the dada line to the preset voltage signal generating circuit or the source driving circuit according to the control signal.

In the present embodiment, the timing controller is located outside the source driver, and the source driver includes only the switching unit. The timing controller realizes the function of the determining unit to determine whether the current time is within the blanking period of time, and to generate a control signal for controlling the switching unit to switch. The control signal includes information about whether the current time is within the blanking period of time between the two frame pictures, and the switching unit realizes the switching.

The source driver provided by the present embodiment outputs the corresponding common voltage signal to the data lines when the current time is within the blanking period of time and outputs the common voltage signal to the data line when the current time is not within the blanking period of time, which avoids charging and discharging of the parasitical capacitance to decrease power consumption of the panel, and also bring any disadvantageous effects to the display effect.

An embodiment of the present disclosure further provides a display device provided with the data line driving unit according to any one of the above mentioned items, or the source driver as mentioned above or the panel driving device as mentioned above. The display device saves power and decreases power consumption, and at the same time may get a higher display quality by reducing the influence of the parasitic capacitance on the display effect. The display device may be a product or a component having a display function such as a liquid crystal panel, an electronic paper, an OLED panel, a mobile phone, a tablet computer, a television set, a display, a notebook computer, a digital photo frame and a navigator.

Various embodiments of the present specification are described in a progressive manner, and identical and similar parts between the various embodiments are referred to each other. Each embodiment will focus on the differences from the other embodiments. In particular, for the method embodiment, since it is substantially similar to the method embodiment, the description is relatively simple, and the correlation can be seen in part of the description of the embodiment of the method.

It will be appreciated by those of ordinary skill in the art that all or a portion of the flow in the method of the embodiments as described above may be accomplished by a computer program that instructs the associated hardware to be stored in a computer-readable storage medium; when executed, a flow of embodiments of the above-described methods may be included. The storage medium may be a magnetic disk, an optical disk, a read-only memory (ROM), or a random access memory (RAM).

While the disclosure has been described in detail, it should be understood that the disclosure is not limited thereto. Any changes or substitutions which may occur to those skilled in the art fall within the scope of the present disclosure. Therefore, the scope of the present disclosure should be determined by the scope of the claims.

1. A data line driving method, comprising steps of:
determining whether current time is within a blanking period of time between two frames;
outputting a preset voltage signal to the data line on a condition that the current time is within the blanking period of time and outputting a gray-scale voltage signal to the data line on a condition that the current time is not within the blanking period of time.

2. The data line driving method according to claim 1, wherein the preset voltage signal is a common voltage signal.

3. The data line driving method according to claim 1, wherein the determining step comprises:
determining, by a data enabling signal, whether the current time is within the blanking period of time between two frames.

4. The data line driving method according to claim 2, wherein the outputting step comprises:
generating a control signal for connecting an input terminal of the data line to a common voltage circuit on a condition that the current time is within the blanking period of time and generating a control signal for connecting the input terminal of the data line to a source driving circuit on a condition that the current time is not within the blanking period of time; and
connecting the input terminal of the data line to the common voltage circuit or the source driving circuit according to the control signal.

5. A data line driving unit comprising:
a determining unit configured for determining whether current time is within a blanking period of time between two frames;
a switching unit configured for connecting an input terminal of the data line to a preset voltage signal generating circuit on a condition that the determining unit determines that the current time is within the blanking period of time, and connecting the input terminal of the data line to a source driving circuit on a condition that the determining unit determines that the current time is not within the blanking period of time.

6. The data line driving unit according to claim 5, wherein the determining unit is further configured for generating a control signal for connecting the input terminal of the data line to the preset voltage signal generating circuit on the condition that the current time is within the blanking period of time, and generating a control signal for connecting the input terminal of the data line to the source driving circuit on the condition that the current time is not within the blanking period of time.

7. The data line driving unit according to claim 5, wherein the preset voltage signal generating circuit is a common voltage circuit.

8. The data line driving unit according to claim 7, wherein a control terminal of the switching unit is connected to the determining unit, a first input terminal of the switching unit is connected to the source driving circuit, a second input terminal of the switching unit is connected to the common voltage circuit, and an output terminal of the switching unit is connected to the input terminal of the data line; and
the switching unit receives the control signal from the determining unit and connects the input terminal of the data line to the common voltage circuit or the source driving circuit according to the control signal.

9. The data line driving unit according to claim 5, wherein the determining unit determines, by a data enabling signal, whether the current time is within the blanking period of time between the two frames.

10. A source driver comprising:
a source driving circuit;
a preset voltage signal generating circuit;
a determining unit configured for determining whether current time is within a blanking period of time between two frames; and
a switching unit configured for connecting an input terminal of the data line to the preset voltage signal generating circuit on a condition that the determining unit determines that the current time is within the blanking period of time, and connecting the input terminal of the data line to the source driving circuit on a condition that the determining unit determines that the current time is not within the blanking period of time.

11. The source driver according to claim 10, wherein the determination unit is a timing controller.

12. The source driver according to claim 10, wherein the determining unit determines, by a data enabling signal, whether the current time is within a blanking period of time between two frames.

13. The source driver according to claim 10, wherein the preset voltage signal generating circuit is a common voltage circuit.

14. (canceled)

15. (canceled)

16. (canceled)
